(19) United States
(12) Patent Application Publication
(10) Pub. No.: US 2023/0418292 A1
(43) Pub. Date: Dec. 28, 2023

(54) WORK VEHICLE, INFORMATION PROCESSING APPARATUS, AND METHOD

(71) Applicant: TOYOTA JIDOSHA KABUSHIKI KAISHA, Toyota-shi (JP)

(72) Inventors: Yuki KUWAYAMA, Yokohama-shi (JP); Takeshi FUJIKI, Shinagawa-ku (JP); Rie MURAI, Chiba-shi (JP); Kohei MIWA, Suntoh-gun (JP); Akira MIYAMOTO, Nisshin-shi (JP); Tsuyoshi OKADA, Nagoya-shi (JP); Yu ITO, Nagoya-shi (JP)

(73) Assignee: TOYOTA JIDOSHA KABUSHIKI KAISHA, Toyota-shi (JP)

(21) Appl. No.: 18/340,466

(22) Filed: Jun. 23, 2023

(30) Foreign Application Priority Data
Jun. 23, 2022 (JP) 2022-101393

(51) Int. Cl. G05D 1/00; A01B 76/00; A01B 69/04

(52) U.S. Cl. CPC G05D 1/0088; A01B 76/00; A01B 69/008; G05D 2201/0201

(57) ABSTRACT

A work vehicle has an automatic driving function and includes a controller configured to control switching of a mode between a public road driving mode and a work mode.

### CROSS-REFERENCE TO RELATED APPLICATION

This application claims priority to Japanese Patent Application No. 2022-101393 filed on Jun. 23, 2022, the entire contents of which are incorporated herein by reference.

### TECHNICAL FIELD

The present disclosure relates to a work vehicle, an information processing apparatus, and a method.

### BACKGROUND

Patent Literature (PTL) 1 discloses a work vehicle with an automatic steering function.

### CITATION LIST

### Patent Literature

PTL 1: JP 2021-153421 A

### SUMMARY

Conventional technology has room for improvement in terms of work vehicles performing automatic driving on public roads between, for example, a shed for storing work vehicles and agricultural land, such as rice paddies or fields. In particular, work vehicles easily become dirty due to mud and the like. Therefore, it is necessary to take measures in case sensors and the like used for automatic driving become dirty.

It would be helpful to improve technology for work vehicles to drive automatically on public roads.

A work vehicle according to an embodiment of the present disclosure is a work vehicle having an automatic driving function and including a controller configured to:
control switching of a mode between a public road driving mode and a work mode.

An information processing apparatus according to an embodiment of the present disclosure is an information processing apparatus including a controller and a communication interface, wherein the controller is configured to instruct, via the communication interface, a work vehicle that has an automatic driving function to switch a mode between a public road driving mode and a work mode.

A method according to an embodiment of the present disclosure is a method to be executed by an information processing apparatus, the method including:
instructing a work vehicle that has an automatic driving function to switch a mode between a public road driving mode and a work mode.

According to an embodiment of the present disclosure, technology for work vehicles to drive automatically on public roads can be improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a work vehicle according to the embodiment of the present disclosure;

FIG. 3 is a block diagram illustrating a schematic configuration of an information processing apparatus according to the embodiment of the present disclosure; and

FIG. 4 is a flowchart illustrating operations of a work vehicle according to an embodiment of the present disclosure.

### DETAILED DESCRIPTION

Hereinafter, an embodiment of the present disclosure will be described.

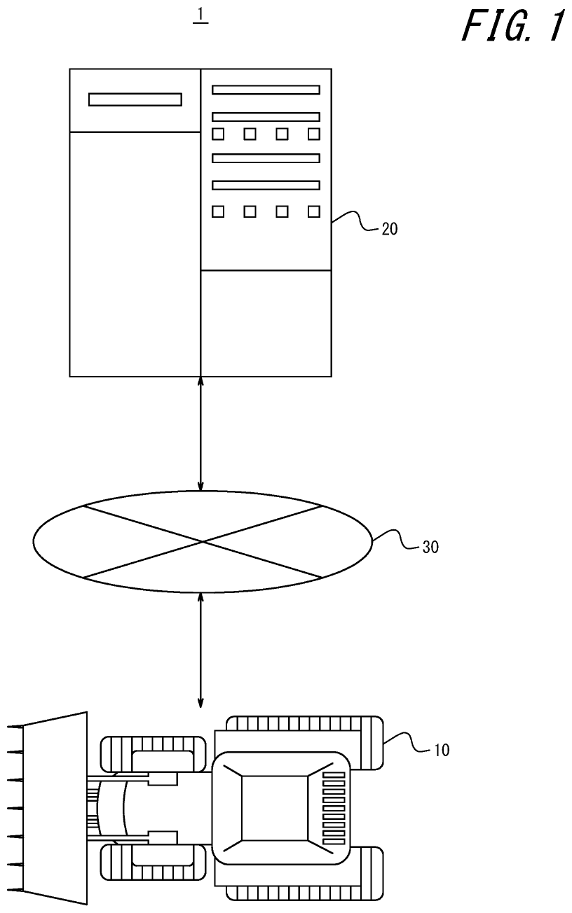

An outline of a system 1 according to an embodiment of the present disclosure will be described with reference to FIG. 1.

The system 1 includes a work vehicle 10 and an information processing apparatus 20. The work vehicle 10 and the information processing apparatus 20 are communicably connected to a network 30.

The work vehicle 10 is an automobile, examples of which include any agricultural machinery such as a tractor, rice transplanter, or combine. The work vehicle 10 is, for example, a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The work vehicle 10 may be driven by a driver, or the driving may be automated at any level. The level of automation is, for example, one of level 1 to level 5 according to the classification of the Society of Automotive Engineers (SAE).

The information processing apparatus 20 is a computer such as a server that belongs to a cloud computing system or another type of computing system.

The network 30 includes the Internet, at least one wide area network (WAN), at least one metropolitan area network (MAN), or any combination thereof. The network 30 may include at least one wireless network, at least one optical network, or any combination thereof. The wireless network is, for example, an ad hoc network, a cellular network, a wireless local area network (LAN), a satellite communication network, or a terrestrial microwave network.

An outline of the present embodiment will be described with reference to FIG. 1. The work vehicle 10 has an automatic driving function. The controller 11 of the work vehicle 10 controls switching of the mode between a public road driving mode and a work mode.

According to the present embodiment, even if the work vehicle 10 becomes dirty due to mud or the like in a work area, such as agricultural land, it is possible to switch between the public road driving mode and the work mode, thus avoiding soiling of sensor modules and the like provided in the work vehicle 10 for automatic driving on public roads. Technology for the work vehicle 10 to drive automatically on public roads can thereby be improved.

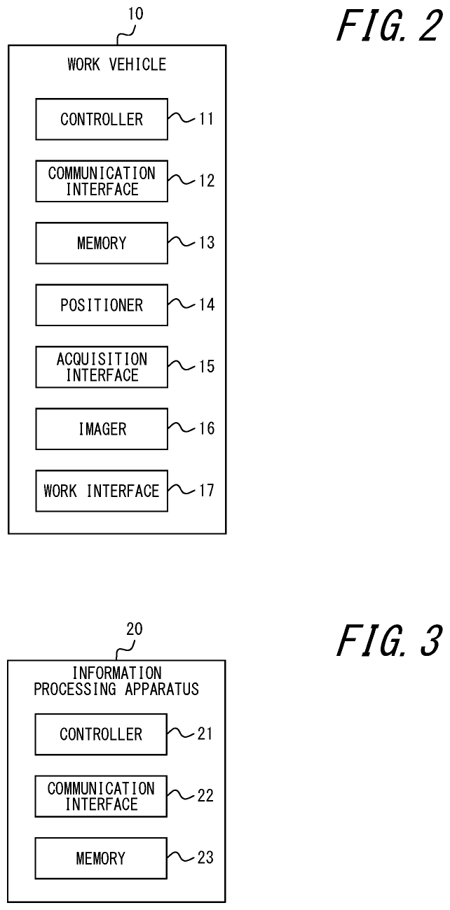

A configuration of the work vehicle 10 according to the present embodiment will be described with reference to FIG. 2.

The work vehicle 10 includes a controller 11, a communication interface 12, a memory 13, a positioner 14, an acquisition interface 15, an imager 16, and a work interface 17.

The controller 11 includes at least one processor, at least one programmable circuit, at least one dedicated circuit, or any combination thereof. The processor is a general purpose processor such as a central processing unit (CPU) or a graphics processing unit (GPU), or a dedicated processor that is dedicated to specific processing. The programmable circuit is, for example, a field-programmable gate array (FPGA). The dedicated circuit is, for example, an application specific integrated circuit (ASIC). The controller 11 executes processes related to the operations of the work vehicle while controlling the components of the work vehicle 10.

The communication interface 12 includes at least one interface for communication. The interface for communication is, for example, an interface compliant with a mobile communication standard such as a Long Term Evolution (LTE), the 4th generation (4G) standard, or the 5th generation (5G) standard, an interface compliant with a short-range wireless communication standard such as Bluetooth® (Bluetooth is a registered trademark in Japan, other countries, or both), or a LAN interface. The communication interface 12 receives data to be used for the operations of the work vehicle 10 and transmits data obtained by the operations of the work vehicle 10.

The memory 13 includes at least one semiconductor memory, at least one magnetic memory, at least one optical memory, or any combination thereof. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 13 functions as, for example, a main memory, an auxiliary memory, or a cache memory. The memory 13 stores data to be used for operations of the work vehicle 10 and data obtained by the operations of the work vehicle 10. In the present embodiment, the data to be used for the operations of the work vehicle 10 includes a system program, an application program, a database, map information, work information, and the like.

The positioner 14 includes one or more receivers compliant with any appropriate satellite positioning system. For example, the positioner 14 includes a Global Positioning System (GPS) receiver. The positioner 14 acquires the measured position of the work vehicle 10 as positional information. The positional information includes an address, a latitude, a longitude, an altitude, and the like. The positioner 14 is capable of acquiring positional information on the work vehicle 10. The positioner 14 may acquire the positional information on the work vehicle 10 continually, regularly, or non-regularly.

The acquisition interface 15 includes one or more sensor modules capable of acquiring information necessary for automatic driving of the work vehicle 10 on public roads. Non-limiting examples of the sensor module include speed sensors, acceleration sensors, angular velocity sensors, or steering angle sensors.

The imager 16 includes one or more imaging modules capable of acquiring any information needed to perform work, including agricultural work. The imaging module includes, for example, one or more cameras. The camera is positioned at an appropriate location on the work vehicle 10 so as to be capable of imaging the surroundings of the work vehicle 10. The imager 16 may be capable of acquiring any information necessary for automatic driving in a work area, such as agricultural land. However, such information is not sufficient for automatic driving on public roads.

The work interface 17 includes one or more work apparatuses for performing work, including agricultural work. Non-limiting examples of the work apparatus include spreading apparatuses for spreading fertilizer or pesticide, seeding apparatuses for seeding rice paddies or fields, or harvesting apparatuses for harvesting crops and the like.

A configuration of the information processing apparatus 20 according to the present embodiment will be described with reference to FIG. 3.

The information processing apparatus 20 includes a controller 21, a communication interface 22, and a memory 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 21 executes processes related to operations of the information processing apparatus 20 while controlling components of the information processing apparatus 20.

The communication interface 22 includes at least one interface for communication. The interface for communication is compliant with, for example, a mobile communication standard, a wired LAN standard, or a wireless LAN standard but is not limited to these and may be compliant with any communication standard. The communication interface 22 receives data to be used for the operations of the information processing apparatus 20 and transmits data obtained by the operations of the information processing apparatus 20.

The memory 23 includes at least one semiconductor memory, at least one magnetic memory, at least one optical memory, or any combination thereof. The semiconductor memory is, for example, RAM or ROM. The RAM is, for example, SRAM or DRAM. The ROM is, for example, EEPROM. The memory 23 functions as, for example, a main memory, an auxiliary memory, or a cache memory. The memory 23 stores data to be used for the operations of the information processing apparatus 20 and data obtained by the operations of the information processing apparatus 20. In the present embodiment, the data to be used for the operations of the information processing apparatus 20 includes a system program, an application program, a database, map information, work information, and the like.

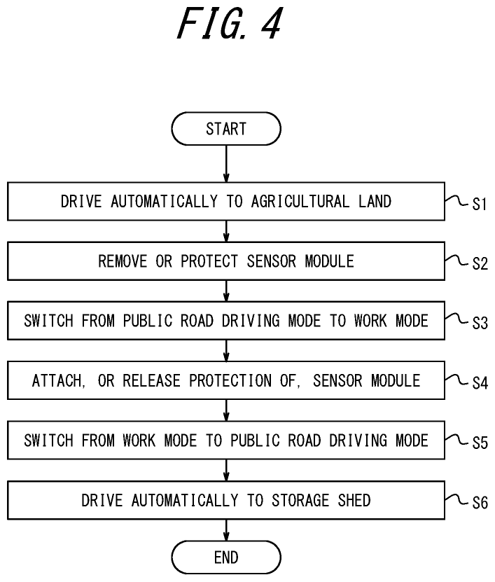

Operations of the work vehicle 10 according to the present embodiment will be described with reference to FIG. 4. These operations correspond to a method according to an embodiment of the present disclosure.

The work vehicle 10 includes a sensor module for automatic driving on public roads as described above. The sensor module may be attachable and removable, or protection can be applied and released, according to the driving mode. The attachment and removal of the sensor module may be performed by any appropriate method, for example using an unmanned aircraft such as a drone. The protection may be applied and released as appropriate by opening and closing any shutter capable of covering the sensor module. In this case, the controller 11 of the work vehicle 10 applies protection to the sensor module by controlling the shutter to close and releases the protection of the sensor module by controlling the shutter to open. Alternatively, the protection of the sensor module may be applied and released by moving the sensor module in or out of the work vehicle 10 by any appropriate movement mechanism attached to the sensor module. In this case, the controller 11 of the work vehicle 10 may apply protection to the sensor module by moving the sensor module inside the work vehicle 10 via the movement mechanism and may release the protection of the sensor module by moving the sensor module outside the work vehicle 10 via the movement mechanism.

Step S1: the controller 11 of the work vehicle 10 confirms that the current mode is the public road driving mode and controls the work vehicle 10 to drive automatically drive from the storage shed to the work area, such as agricultural land.

Specifically, the controller 11 of work vehicle 10 performs steering control, accelerator control, brake control, and the like of the work vehicle 10 using information acquired by the positioner 14 and the acquisition interface so that according to a driving plan acquired in advance from the information processing apparatus 20 via the communication interface 12, the work vehicle 10 is controlled to drive automatically on a public road from the storage shed to the work area, such as agricultural land. The travel plan may include, but is not limited to, destination information indicating the location of the destination, such as the agricultural land; travel route information to the destination; the estimated time of departure from the departure point, such as the storage shed; and the estimated time of arrival at the destination.

Step S2: upon detecting arrival at the work area, such as agricultural land, the controller 11 of the work vehicle 10 removes or protects the sensor module.

Specifically, upon detecting arrival at the work area, such as agricultural land, based on the positional information for the work vehicle 10 acquired by the positioner 14, the controller 11 of work vehicle 10 removes or protects the sensor module by the above-described method. This can prevent the sensor module from becoming dirty due to mud or the like as a result of the work described below. In a case in which the work vehicle 10 is equipped with any appropriate input interface, the arrival at the work area, such as agricultural land, may be detected by operation of the input interface by the operator, but this example is not limiting.

Step S3: upon detecting the removal or protection of the sensor module, the controller 11 of the work vehicle 10 switches the mode from the public road driving mode to the work mode.

Specifically, in the work mode, the controller 11 of the work vehicle performs steering control, accelerator control, brake control, and the like of the work vehicle 10 using the information acquired by the imager 16, thereby enabling the work vehicle 10 to drive automatically in the work area, such as agricultural land. In the work mode, the controller 11 of the work vehicle 10 controls the operation of the work interface 17 based on the work information acquired in advance or at any appropriate timing from the information processing apparatus 20 via the communication interface 12, so as to enable, for example, the spreading of fertilizer or pesticides, the seeding of rice paddies or fields, or the harvesting of crops.

Step S4: upon detecting completion of work, the controller 11 of the work vehicle 10 attaches, or releases protection of, the sensor module.

Specifically, upon detecting completion of work based on information acquired by the imager 16, the controller 11 of the work vehicle 10 attaches, or releases protection of, the sensor module by the above-described method. In a case in which the work vehicle 10 is equipped with any appropriate input interface, the completion of work may be detected by operation of the input interface by the operator, but this example is not limiting.

Step S5: upon detecting the attachment or release of protection of the sensor module, the controller 11 of the work vehicle 10 switches the mode from the work mode to the public road driving mode.

Step S6: the controller 11 of the work vehicle 10 controls the work vehicle 10 to drive automatically from the work area, such as agricultural land, to the storage shed.

Specifically, the controller 11 of work vehicle 10 performs steering control, accelerator control, brake control, and the like of the work vehicle 10 using information acquired by the positioner 14 and the acquisition interface so that according to a driving plan acquired in advance from the information processing apparatus 20 via the communication interface 12, the work vehicle 10 is controlled to drive automatically on a public road from the work area, such as agricultural land, to the storage shed. The travel plan may include, but is not limited to, destination information indicating the location of the destination, such as the storage shed; travel route information to the destination; the estimated time of departure from the departure point, such as the agricultural land; and the estimated time of arrival at the destination.

As described above, the work vehicle 10 according to the present embodiment has an automatic driving function. The controller 11 of the work vehicle 10 controls switching of the mode between a public road driving mode and a work mode.

According to this configuration, even if the work vehicle 10 becomes dirty due to mud or the like in a work area, such as agricultural land, it is possible to switch between the public road driving mode and the work mode, thus avoiding soiling of sensor modules and the like provided in the work vehicle 10 for automatic driving on public roads. Technology for the work vehicle 10 to drive automatically on public roads can thereby be improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

As a variation, an embodiment in which some of the constituent elements of the work vehicle 10 are provided in the information processing apparatus 20 is also possible. In this variation, the controller 21 of the information processing apparatus 20 instructs, via the communication interface 22, the work vehicle 10 that has an automatic driving function to switch a mode between a public road driving mode and a work mode. For example, upon detecting arrival of the work vehicle 10 at a work area such as agricultural land, the controller 21 of the information processing apparatus 20 instructs, via the communication interface 22, the work vehicle 10 to remove the sensor module or apply protection to the sensor module and to switch from the public road driving mode to the work mode. As another example, upon detecting completion of work such as agricultural work, the controller 21 of the information processing apparatus 20 instructs, via the communication interface 22, the work vehicle 10 to attach the sensor module or release protection of the sensor module and to switch from the work mode to the public road driving mode. Other than these points, the explanation of each step in the above-described embodiment applies.

As a variation, attachment of the sensor module or release of protection of the sensor module may be omitted in step S4 in the above-described embodiment, in which case it suffices for the work vehicle 10 to be driven manually to the storage shed.

As a variation, in a case in which the above-described sensor module is removable, the sensor module that is removed when not needed during work, such as agricultural work, may be stored at any appropriate location, such as a management center. The above-described sensor module may be used in common (shared) among a plurality of work vehicles 10. For example, suppose that when a first work vehicle 10 arrives at the agricultural land from the storage shed and is about to start the agricultural work, a second work vehicle 10 is about to return from the agricultural land to the storage shed. In this case, the sensor module attached to the first work vehicle 10 is removed from the first work vehicle 10 and attached to the second work vehicle 10 by, for example, a worker or an unmanned aircraft such as a drone, so that the first and second work vehicles 10 can share the sensor module.

As a variation, an embodiment in which a general purpose computer functions as the information processing apparatus 20 according to the above embodiment can also be implemented. Specifically, a program in which processes for realizing the functions of the information processing apparatus according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.
[Appendix 1] A work vehicle having an automatic driving function and comprising a controller configured to:

control switching of a mode between a public road driving mode and a work mode.
[Appendix 2] The work vehicle according to appendix 1, further comprising a sensor module for automatic driving on public roads.
[Appendix 3] The work vehicle according to appendix 2, wherein upon detecting arrival of the work vehicle at a work area, the controller is configured to remove the sensor module or apply protection to the sensor module and to switch from the public road driving mode to the work mode.
[Appendix 4] The work vehicle according to appendix 2 or 3, wherein upon detecting completion of work, the controller is configured to attach the sensor module or release protection of the sensor module and to switch from the work mode to the public road driving mode.
[Appendix 5] The work vehicle according to appendix 3 or 4, wherein the protection is applied or released by opening or closing a shutter capable of covering the sensor module.
[Appendix 6] The work vehicle according to appendix 3 or 4, wherein the protection is applied or released by moving the sensor module in or out of the work vehicle.
[Appendix 7] The work vehicle according to any one of appendices 2 to 6, wherein the sensor module can be shared among a plurality of work vehicles.
[Appendix 8] An information processing apparatus comprising a controller and a communication interface, wherein
   the controller is configured to instruct, via the communication interface, a work vehicle that has an automatic driving function to switch a mode between a public road driving mode and a work mode.
[Appendix 9] The information processing apparatus according to appendix 8, wherein the work vehicle further comprises a sensor module for automatic driving on public roads.
[Appendix 10] The information processing apparatus according to appendix 9, wherein upon detecting arrival of the work vehicle at a work area, the controller is configured to instruct, via the communication interface, the work vehicle to remove the sensor module or apply protection to the sensor module and to switch from the public road driving mode to the work mode.
[Appendix 11] The information processing apparatus according to appendix 9 or 10, wherein upon detecting completion of work, the controller is configured to instruct, via the communication interface, the work vehicle to attach the sensor module or release protection of the sensor module and to switch from the work mode to the public road driving mode.
[Appendix 12] The information processing apparatus according to appendix or 11, wherein the protection is applied or released by opening or closing a shutter capable of covering the sensor module.
[Appendix 13] The information processing apparatus according to appendix or 11, wherein the protection is applied or released by moving the sensor module in or out of the work vehicle.
[Appendix 14] The information processing apparatus according to any one of appendices 9 to 13, wherein the sensor module can be shared among a plurality of work vehicles.
[Appendix 15] A method to be executed by an information processing apparatus, the method comprising:
   instructing a work vehicle that has an automatic driving function to switch a mode between a public road driving mode and a work mode.
[Appendix 16] The method according to appendix 15, wherein the work vehicle further comprises a sensor module for automatic driving on public roads.
[Appendix 17] The method according to appendix 16, further comprising removing, upon detecting arrival of the work vehicle at a work area, the sensor module or applying protection to the sensor module and switching from the public road driving mode to the work mode.
[Appendix 18] The method according to appendix 16 or 17, further comprising attaching, upon detecting completion of work, the sensor module or releasing protection of the sensor module and switching from the work mode to the public road driving mode.
[Appendix 19] The method according to appendix 17 or 18, wherein the protection is applied or released by opening or closing a shutter capable of covering the sensor module.
[Appendix 20] The method according to appendix 17 or 18, wherein the protection is applied or released by moving the sensor module in or out of the work vehicle.

1. A work vehicle having an automatic driving function and comprising a controller configured to:
control switching of a mode between a public road driving mode and a work mode.

2. The work vehicle according to claim 1, further comprising a sensor module for automatic driving on public roads.

3. The work vehicle according to claim 2, wherein upon detecting arrival of the work vehicle at a work area, the controller is configured to remove the sensor module or apply protection to the sensor module and to switch from the public road driving mode to the work mode.

4. The work vehicle according to claim 2, wherein upon detecting completion of work, the controller is configured to attach the sensor module or release protection of the sensor module and to switch from the work mode to the public road driving mode.

5. The work vehicle according to claim 3, wherein the protection is applied or released by opening or closing a shutter capable of covering the sensor module.

6. The work vehicle according to claim 3, wherein the protection is applied or released by moving the sensor module in or out of the work vehicle.

7. The work vehicle according to claim 2, wherein the sensor module can be shared among a plurality of work vehicles.

8. An information processing apparatus comprising a controller and a communication interface, wherein
the controller is configured to instruct, via the communication interface, a work vehicle that has an automatic driving function to switch a mode between a public road driving mode and a work mode.

9. The information processing apparatus according to claim 8, wherein the work vehicle further comprises a sensor module for automatic driving on public roads.

10. The information processing apparatus according to claim 9, wherein upon detecting arrival of the work vehicle at a work area, the controller is configured to instruct, via the communication interface, the work vehicle to remove the sensor module or apply protection to the sensor module and to switch from the public road driving mode to the work mode.

11. The information processing apparatus according to claim 9, wherein upon detecting completion of work, the controller is configured to instruct, via the communication interface, the work vehicle to attach the sensor module or release protection of the sensor module and to switch from the work mode to the public road driving mode.

12. The information processing apparatus according to claim 10, wherein the protection is applied or released by opening or closing a shutter capable of covering the sensor module.

13. The information processing apparatus according to claim 10, wherein the protection is applied or released by moving the sensor module in or out of the work vehicle.

14. The information processing apparatus according to claim 9, wherein the sensor module can be shared among a plurality of work vehicles.

15. A method to be executed by an information processing apparatus, the method comprising:
instructing a work vehicle that has an automatic driving function to switch a mode between a public road driving mode and a work mode.

16. The method according to claim 15, wherein the work vehicle further comprises a sensor module for automatic driving on public roads.

17. The method according to claim 16, further comprising removing, upon detecting arrival of the work vehicle at a work area, the sensor module or applying protection to the sensor module and switching from the public road driving mode to the work mode.

18. The method according to claim 16, further comprising attaching, upon detecting completion of work, the sensor module or releasing protection of the sensor module and switching from the work mode to the public road driving mode.

19. The method according to claim 17, wherein the protection is applied or released by opening or closing a shutter capable of covering the sensor module.

20. The method according to claim 17, wherein the protection is applied or released by moving the sensor module in or out of the work vehicle.
